(19) United States
(12) Patent Application Publication
(10) Pub. No.: US 2008/0004991 A1
(43) Pub. Date: Jan. 3, 2008

(54) Methods and apparatus for global service management of configuration management databases

(75) Inventors: Glenn C. Aikens, Raleigh, NC (US); Naga A. Ayachitula, Elmsford, NY (US); Messaoud B. Benantar, Austin, TX (US); Krishna S. Garimella, San Jose, CA (US); Hari Haranath Madduri, Austin, TX (US); Yan Or, San Francisco, CA (US); Larisa Shwartz, Scarsdale, NY (US); Maheswaran Surendra, Croton-On-Hudson, NY (US); Steve Weinberger, Lewis Center, OH (US)

Correspondence Address: RYAN, MASON & LEWIS, LLP, 90 FOREST AVENUE, LOCUST VALLEY, NY, 11560, US

(73) Assignee: International Business Machines Corporation, Armonk, NY (US)

(21) Appl. No.: 11/478,747

(22) Filed: Jun. 30, 2006

(51) Int. Cl. G06Q 30/00

(52) U.S. Cl. 705/27

(57) ABSTRACT

A global service management configuration comprises a plurality of interrelated administrative objects. One or more of the plurality of interrelated administrative objects provide access control of one or more of a plurality of configuration items of a configuration management database by at least one of the plurality of interrelated administrative objects.

### CROSS REFERENCE TO RELATED APPLICATIONS

This application is related to: the U.S. Patent Application Attorney Docket No. YOR920060467US1, entitled “Methods and Apparatus for Composite Configuration Item Management in Configuration Management Database;” the U.S. Patent Application Attorney Docket No. YOR920060469US1, entitled “Methods and Apparatus for Automatically Creating Composite Configuration Items in Configuration Management Database;” the U.S. Patent Application Attorney Docket No. YOR920060477US1, entitled “Methods and Apparatus for Scoped Role-Based Access Control;” and the U.S. Patent Application Attorney Docket No. YOR920060478US1, entitled “Methods and Apparatus for Managing Configuration Management Database via Composite Configuration Item Change History” which are filed concurrently herewith and incorporated by reference herein.

### FIELD OF THE INVENTION

The present invention relates to information technology (IT) service management and, more particularly, to methods and apparatus of global service management of a configuration management database (CMDB).

### BACKGROUND OF THE INVENTION

In the management of configuration data in a managed IT environment, it is best practice to make use of a logically centralized repository for the storage and access of the data, commonly referred to as a configuration management database (CMDB). The configuration data stored in this CMDB includes a representation of managed resources; such a representation is called a configuration item (CI). The CMDB records the existence, attributes, relationships, history and status of CIs. An attribute is a descriptive characteristic of a CI such as, for example, make, model, serial number, or location. A relationship describes associations, such as, for example, the dependency and/or connectivity between CIs.

Service provider organizations are looking for the opportunity to gain economies of scale in their technology investments by replacing dedicated account specific systems with solutions that can be shared across accounts. These economies of scale are driven by the elimination of dedicated technology license pools. As well as greatly reduced hardware requirements, by sharing resources across accounts. Further, the economies of scale are driven by dramatic reductions in IT management costs resulting from the consolidation of technology resources.

With well-designed data segregation, service business units can leverage a common pool of agents and their predefined profiles. The service business units may also fully segment private data between accounts or clients, or generate reports that aggregate data across accounts for strategic analysis. Finally, the service business units provide management personnel with a real-time view of organizational performance across business units.

These benefits have special value to service providers because they need to measure performance relative to each corporate client as well as an overall basis for themselves. By the nature of its business, the service management requires flexibility of administrative data in relation to configuration management data, the assignment of personnel to different levels of data structures, as well as the ability to extend lists of tasks that could be performed by its personnel.

A number of attempted solutions provide non-extendable data models or have hard-wired administration structures to the configuration data. For example, a common approach is to have a relationship between support personnel and the CIs directly. While this allows full coverage of the configuration data, it is inefficient and inflexible.

### SUMMARY OF THE INVENTION

In accordance with the aforementioned and other objectives, the present invention is directed towards an apparatus and method for multi-account data segregation in a CMDB without requiring substantial changes to existing objects and structures.

For example, in one aspect of the present invention, a global service management configuration comprises a plurality of interrelated administrative objects. One or more of the plurality of interrelated administrative objects provide access control of one or more of a plurality of configuration items of a configuration management database by at least one of the plurality of interrelated administrative objects.

In an additional embodiment of the present invention, the one or more of the plurality of interrelated administrative objects comprise at least one derived user-role object that provides access control of one or more of the plurality of configuration items by at least one user in a role based on a given user and a given role.

In a further additional embodiment of the present invention, the one or more of the plurality of interrelated administrative objects comprise at least one access collection object associated with at least one other of the plurality of interrelated administrative objects for access control of one or more of the plurality of configuration items by the at least one other of the plurality of interrelated administrative objects.

In another aspect of the invention, a method, apparatus and article of manufacture are provided for global service management of a control management database. One or more of a plurality of configuration items of the configuration management database are assigned to one or more of a plurality of interrelated administrative objects. Access control of the one or more of a plurality of configuration items of the configuration management database is provided by at least one of the plurality of interrelated administrative objects though the one or more of the plurality of interrelated administrative objects.

It is therefore also an objective of the present invention to provide a method and apparatus that provides flexible and extensible data segregation; the assignment of people to one or different sets of CIs; and the ability to extend list of tasks that could be performed by the personnel.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating a standard service management configuration for a multi-account structure;

FIG. 2 is a diagram illustrating a data driven access control configuration, according to an embodiment of the present invention;

FIG. 3 is a diagram illustrating a multi-customer service management configuration, according to an embodiment of the present invention;

FIG. 4 is a diagram illustrating a two-step authentication process for the multi-customer service management configuration, according to an embodiment of the present invention;

FIG. 5 is a flow diagram illustrating a global service management methodology for a control management database, according to an embodiment of the present invention; and

FIG. 6 is a diagram illustrating an illustrative hardware implementation of a computing system in accordance with which one or more components/methodologies of the present invention may be implemented, according to an embodiment of the present invention.

### DETAILED DESCRIPTION OF PREFERRED EMBODIMENTS

As will be illustrated in detail below, the present invention introduces techniques for global management of a CMDB for multi-account configurations.

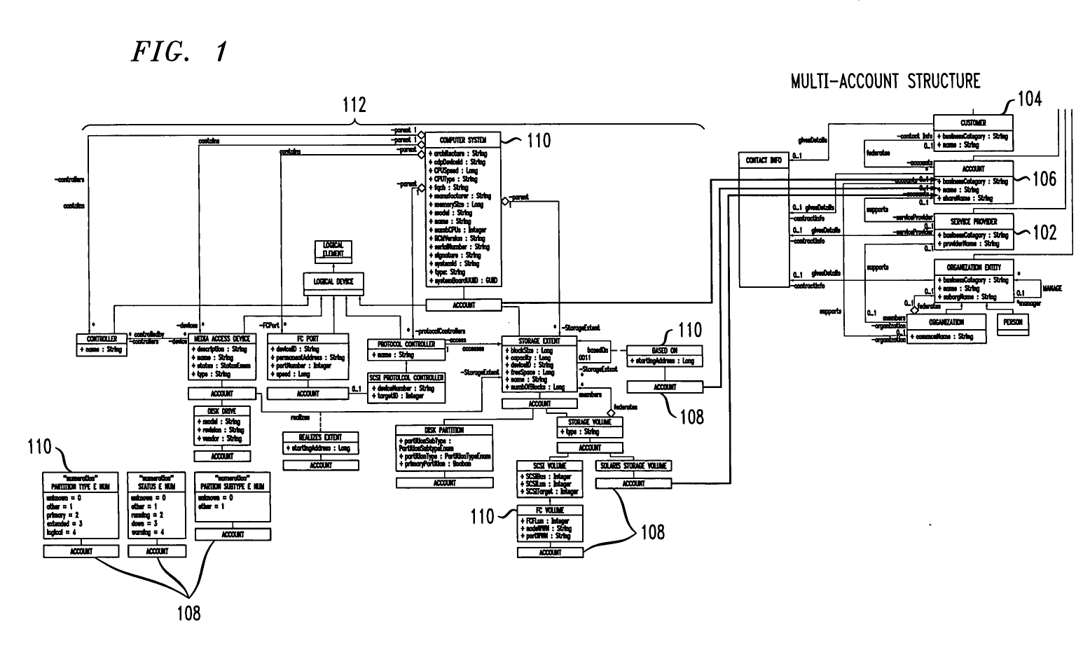

Referring initially to FIG. 1, a diagram illustrates a standard service management configuration with a multi-account structure. In order to provide a multi-account structure for a service provider 102 for the full-in-house service management, data is segregated by customer 104 and/or account 106. This is a requirement that has to be satisfied for any offering to an application service provider. In this configuration, in order to achieve the multi-account structure, customer or account references 108 may be built into each CI 110 stored in a CMDB 112. References to a specific organization or person may also be built into desired CIs. This potentially creates a significant number of references, making it difficult to work with CIs 110, and affecting the ease of use as well as performance of the solution. This approach is especially costly when the addition has to be made to already existing design or implementation of CMDB 112, because it affects each object or table, thereby dramatically increasing of implementation and testing time. For example, it is known for such a configuration to have CMDB 112 with more than 700 types of CI 110.

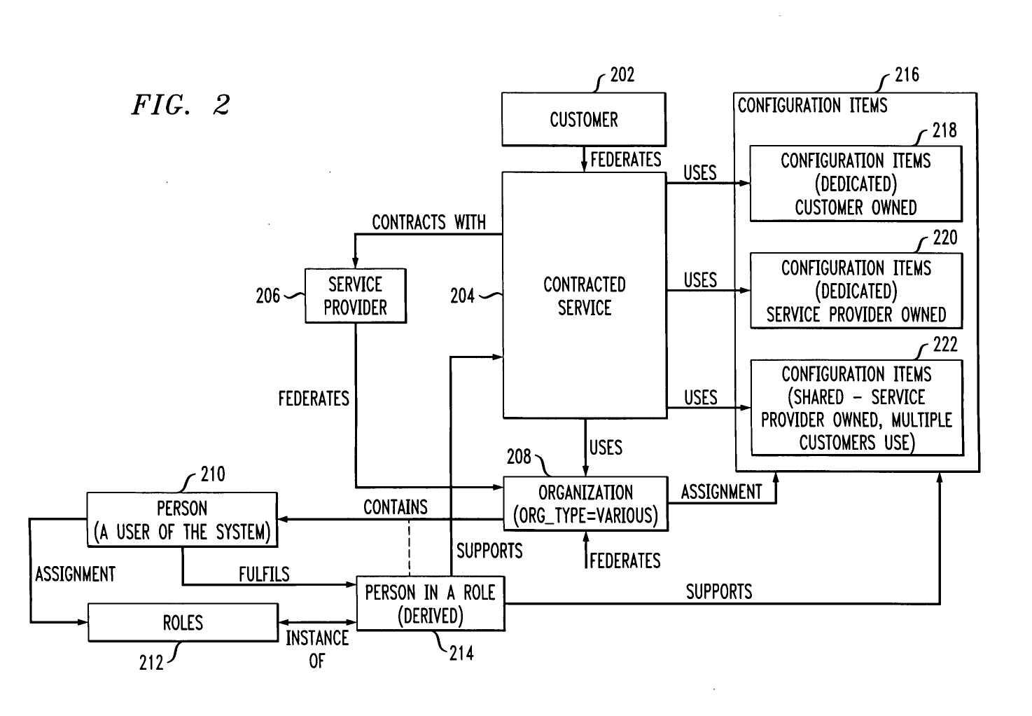

Referring now to FIG. 2, a diagram illustrates a data driven access control configuration, according to an embodiment of the present invention. Specific administrative objects are created in the configuration having specified relationships. A customer object 200 federates a contracted service object 204. Contracted service object 204 contracts with a service provider object 206. A service provider can subdivide its support structures into various organizations based on how the service provider plans on supporting the given service. Service provider object 206 federates an organization object 208, which is used by contracted service object 204.

Organization object 208 contains a person object 210, which is assigned to a role object 212, thereby fulfilling a person in a role object 214. Examples of such roles include a configuration manager, a configuration librarian, a configuration item owner, a change manager, and a release manager.

A person in a role is created outside of the context of an organization. The person is trained to play a certain role in a given system. An organization contains people, which are assigned resources. When a person is assigned to support a resource by a support manager, the support manager selects a person who is assigned to his organization which can play the required role. Once selected, a support relationship is set up between a device object representing that person in a role and the CIs that person playing that role supports. The functions available for a person to execute are managed in the role definition, which CIs these functions can be executed on are managed via a relationship between the instances of that role related to a given person and the CI itself. This embodiment of the present invention allows for easy creation of new resource types, new roles, and the modification of rights on each role independent of each other.

A person in a role is a derived object used to represent the union of a person in a role supporting a given CI 216. Organization object 208 assigns CIs 216 and contracted service object 204 uses CIs 216. CIs 216 are assigned to organizations which have some set of responsibility to ensure the CIs are maintained. Multiple people may be assigned to support the same CI having different roles. Multiple people may be assigned to support the same CI having the same role. A person in a role has a relationship to a CI in order to grant access, or the person in a role could be assigned at the contracted service level, which transitively would allow the person a role to support all resources used by the contracted service. This is done to simplify the methodology in the case where a single person/role combination is designed to act on all data objects of a given organization construct in the data management system.

A customer may require service provider object 206 to support CIs 216 that the customer themselves own. They may also use resources which the service provider owns. Thus, CIs 216 may be segregated into customer owned CIs 218, service provider owned CIs 220, and shared CIs 222. Shared CIs 222 are service provider owned, but may be used by multiple customers.

The data driven access control provides a single relationship type to define access control to records, groups of records, objects or other identifiable data constructs. Access control is provided at a level of granularity specified by the data management system. The complexity of customer and contracted service are not apparent to the person using the system for a given set of roles. Traversing the relationship backwards allows a person to see who supports a given construct.

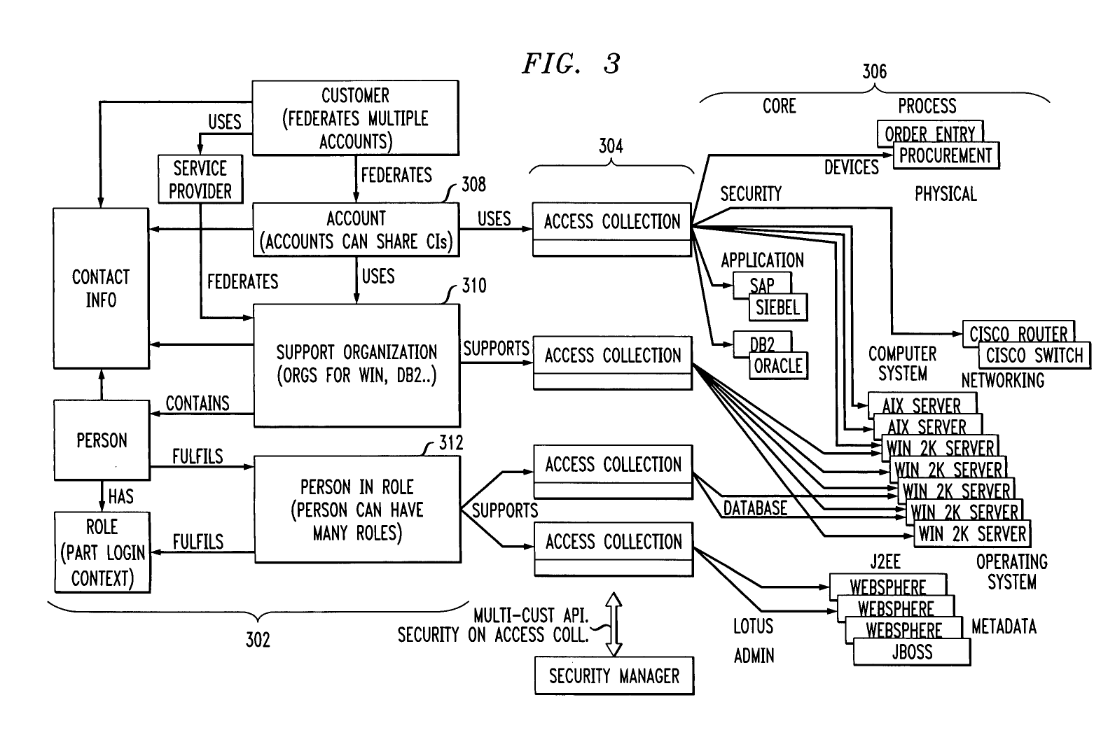

Referring now to FIG. 3, a diagram illustrates a multi-account service management configuration, according to an embodiment of the present invention. In addition to multi-account objects 302, multi-account design includes access collection objects 304. Access collection objects 304 are security-specific containers that have CIs 306 as members for the purposes of access control. In order to satisfy requirements of maintaining CIs 306 assignment to account and organization objects 308, 310, the configuration associates account objects 308 with access collection objects 304 that have as members all CIs 306 assigned to this account. Similarly, organization object 310 has access collection objects 304 that have as members all CIs 306 assigned to the organization. Finally, person in role object 312 has access collection objects 304 that have as members all CIs 306 assigned to that person in the specific role. In addition, access collection objects 304 may also contain a set of unrelated CIs 306.

As described above, access collection objects 304 of FIG. 3 are security-specific containers. More specifically, a security manager 314 may multi-cast application program interface security on access collection objects 304. Because all access to CIs is through access collection objects 304, security is applied at access collection objects 304 and not individual CIs.

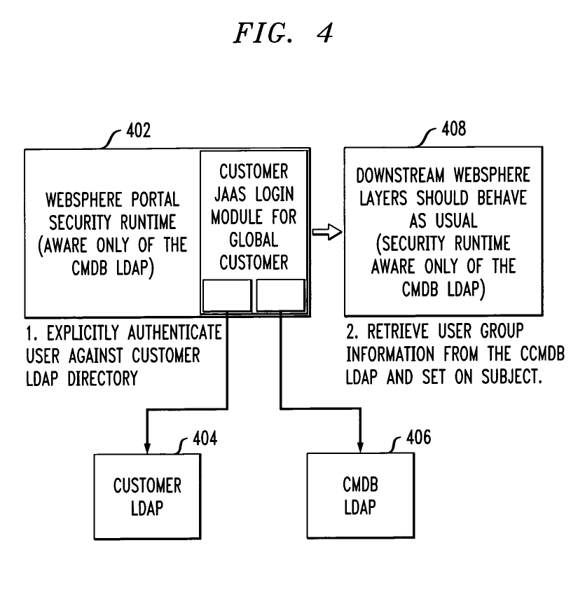

Referring now to FIG. 4, a diagram illustrates a two-step authentication process for the multi-customer service management configuration, according to an embodiment of the present invention. More specifically, the embodiment of FIG. 4 illustrates authentication in a Websphere environment. For the multi-account embodiment, instead of connecting the infrastructure including the server to the customer lightweight directory access protocol (LDAP) directory, the internal LDAP is used to perform user authentication through a custom Java authentication and authorization service (JAAS) login module. The user is setup with role information as retrieved from the internal LDAP registry. The role information then flows as part of the subject to downstream layers such as CMDB.

The user logs on to the CMDB system through a portal 402, enters a user ID and password. These credentials are used to authenticate the user against a customer LDAP directory 404. Upon successful authentication, the user ID is used to retrieve the corresponding user role information out of the internal LDAP registry 406. The subject is then set with this user information. As shown in block 408, downstream layers behave as usual because they are only aware of the internal LDAP.

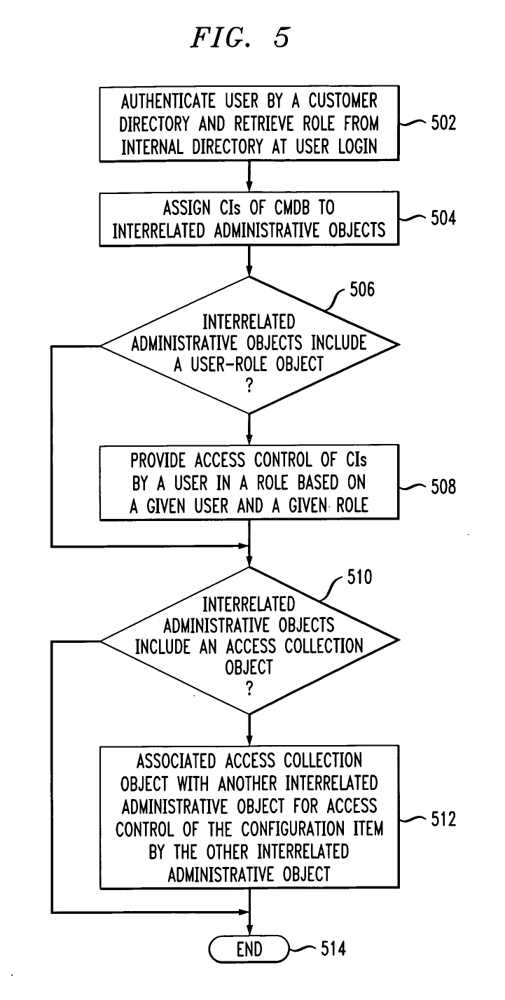

Referring now to FIG. 5, a flow diagram illustrates a global service management methodology for a control management database, according to an embodiment of the present invention. The methodology begins in block 502 where a user is authenticated by a customer directory, and a user role is retrieved from an internal directory at user login. In block 504, CIs of the CMDB are assigned to interrelated administrative objects. In block 506, it is determined if the interrelated administrative objects include at least one user-role object. If they include at least one user-role object, access control of configuration items is provided by at least one user in a role based on a given user and a given role in block 508. If they do not include at least one user-role object the methodology proceeds to block 510 where it is determined if the interrelated administrative objects include at least one access collection object. If they include at least one access collection object, the at least one access collection object is associated with at least one other interrelated administrative object for access control of the configuration items by the at least one other interrelated administrative object in block 512. If they do not include at least one access collection object the methodology terminates in block 514.

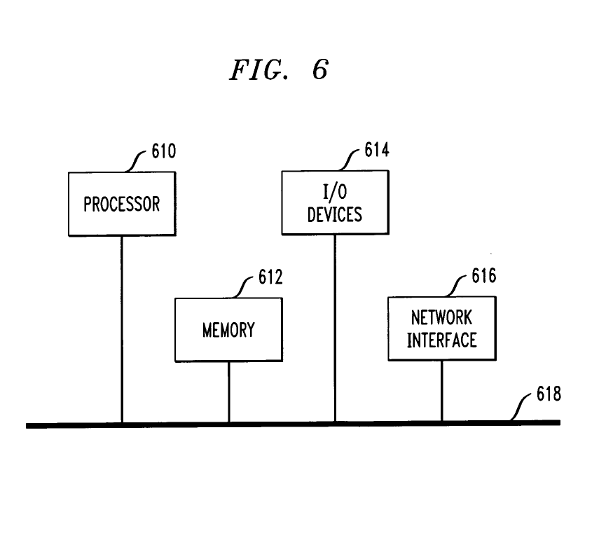

Referring now to FIG. 6, a block diagram illustrates an exemplary hardware implementation of a computing system in accordance with which one or more components/methodologies of the invention (e.g., components/methodologies described in the context of FIGS. 1-5) may be implemented, according to an embodiment of the present invention.

As shown, the computer system may be implemented in accordance with a processor 610, a memory 612, I/O devices 614, and a network interface 616, coupled via a computer bus 618 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

Still further, the phrase “network interface” as used herein is intended to include, for example, one or more transceivers to permit the computer system to communicate with another computer system via an appropriate communications protocol.

Software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A global service management configuration comprising a plurality of interrelated administrative objects, wherein one or more of the plurality of interrelated administrative objects provide access control of one or more of a plurality of configuration items of a configuration management database by at least one of the plurality of interrelated administrative objects.

2. The global service management configuration of claim 1, wherein the plurality of interrelated administrative objects comprise at least one of one or more customer objects, one or more account objects, one or more service provider objects, one or more organization objects, one or more user objects, one or more role objects, and one or more user-role objects.

3. The global service management configuration of claim 2, wherein the plurality of configuration items comprise at least one of one or more configuration items dedicated to at least one of the one or more customer objects, one or more configuration items dedicated to at least one of the one or more service provider objects, and one or more configuration items shared by at least one of the one or more customer objects and at least one of the one or more service provider objects.

4. The global service management configuration of claim 2, wherein the at least one of the one or more user objects is assigned to at least one of the one or more organization objects.

5. The global service management configuration of claim 2, wherein one or more of the plurality of configuration items are assigned to the at least one of the one or more organization objects.

6. The global service management configuration of claim 1, wherein the one or more of the plurality of interrelated administrative objects comprise at least one derived user-role object that provides access control of one or more of the plurality of configuration items by at least one user in a role based on a given user and a given role.

7. The global service management configuration of claim 6, wherein the given role defines one or more functions available for execution by a user, and a relationship between the given role and the given user defines one or more or the plurality of configuration items upon which the one or more functions are executable.

8. The global service management configuration of claim 6, wherein the one or more of the plurality of configuration items are controlled by at least one other user having a different role.

9. The global service management configuration of claim 6, wherein the given user is authenticated and the given role of the given user is retrieved from a registry upon user login at a custom login module.

10. The global service management configuration of claim 9, wherein the given user is authenticated against a customer lightweight directory access protocol directory.

11. The global service management configuration of claim 9, wherein the given role is retrieved from an information technology service management lightweight directory access protocol directory.

12. The global service management configuration of claim 9, wherein the custom login module comprises a Java authentication and authorization service login module.

13. The global service management configuration of claim 1, wherein the one or more of the plurality of interrelated administrative objects comprise at least one access collection object associated with at least one other of the plurality of interrelated administrative objects for access control of one or more of the plurality of configuration items by the at least one other of the plurality of interrelated administrative objects.

14. The global service management configuration of claim 13, wherein the at least one other of the plurality of interrelated administrative objects comprises at least an account object and the one or more of the plurality of configuration items comprise one or more configuration items assigned to the account object.

15. The global service management configuration of claim 13, wherein the at least one other of the plurality of interrelated administrative objects comprises at least an organization object and the one or more of the plurality of configuration items comprise one or more configuration items assigned to the organization object.

16. The global service management configuration of claim 13, wherein the at least one other of the plurality of interrelated administrative objects comprises at least a user-role object and the one or more of the plurality of configuration items comprise one or more configuration items assigned to the user-role object.

17. The global service management configuration of claim 13, wherein the at least one access collection object comprises at least one secure container having at least one of the plurality of configuration items as members.

18. The global service management configuration of claim 13, wherein security for the plurality of configuration items is implemented at the at least one access collection object.

19. A method of global service management of a control management database comprising the steps of:
assigning one or more of a plurality of configuration items of the configuration management database to one or more of a plurality of interrelated administrative objects; and
providing access control of the one or more of a plurality of configuration items of the configuration management database by at least one of a plurality of interrelated administrative objects through the one or more of the plurality of interrelated administrative objects.

20. The method of claim 19, wherein, in the assigning step, the one or more of the plurality of interrelated administrative objects comprise at least one derived user-role object, and the providing step comprises the step of providing access control of the one or more of the plurality of configuration items by at least one user in a role based on a given user and a given role.

21. The method of claim 20, further comprising the step of authenticating the given user and retrieving the given role of the given user from a registry upon user login at a custom login module.

22. The method of claim 19, wherein, in the assigning step, the one or more of the plurality of interrelated administrative objects comprise at least one access collection object, and the providing step comprises the step of associating the at least one access collection object with at least one other of the plurality of interrelated administrative objects for access control of the one or more of the plurality of configuration items by the at least one other of the plurality of interrelated administrative objects.

23. Apparatus for global service management of a control management database, comprising:
a memory; and
at least one processor coupled to the memory and operative to: (i) assign one or more of a plurality of configuration items of the configuration management database to one or more of a plurality of interrelated administrative objects; and (ii) provide access control of the one or more of a plurality of configuration items of the configuration management database by at least one of a plurality of interrelated administrative objects through the one or more of the plurality of interrelated administrative objects.

24. An article of manufacture for global service management of a control management database, comprising a machine readable medium containing one or more programs which when executed implement the steps of:
assigning one or more of a plurality of configuration items of the configuration management database to one or more of a plurality of interrelated administrative objects; and
providing access control of the one or more of a plurality of configuration items of the configuration management database by at least one of a plurality of interrelated administrative objects through the one or more of the plurality of interrelated administrative objects.
